(19) United States
(12) Patent Application Publication
(10) Pub. No.: US 2007/0077140 A1
(43) Pub. Date: Apr. 5, 2007

(54) Packaging for dispensing a fluid

(76) Inventors: Shimon Silberfenig, Calabasas, CA (US); Lori L. Klein, Calabasas, CA (US)

Correspondence Address: LAW OFFICES OF ERIC KARICH, 2807 ST. MARK DR., MANSFIELD, TX, 76063, US

(21) Appl. No.: 11/242,278

(22) Filed: Oct. 3, 2005

(51) Int. Cl. F03B 13/00; F04B 53/00; F01D 15/00

(52) U.S. Cl. 415/121.3; 417/313

(57) ABSTRACT

A packaging for dispensing a fluid, such as a lotion, includes a container for containing the fluid; a pump assembly adapted for dispensing the fluid from the container; a fan housing mounted on the container; a fan assembly rotatably mounted on the fan housing and operably connected to the fan assembly; a motor mounted in the fan housing; a battery; and a switch operably connecting the motor and the battery.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to a product packaging that functions to dispense a fluid, and more particularly to a product packaging that includes a fan for both attracting a potential buyer and for cooling the buyer once the fluid has been applied.

2. Description of Related Art

The following art defines the present state of this field:

Junkel, et al., U.S. Pat. No. 5,965,067, teaches a portable fan device for use with a spray misting bottle. The fan device is adapted to be mounted atop a spray misting bottle so that a fan blade unit of the fan device is positioned forwardly and in communication with an atomized spray nozzle of the spray head and cools and atomizes the mist spray issued by the nozzle.

The prior art teaches a wide variety of similar misting/atomizing type devices that are adapted to work with fans, and related devices, including Licudine, U.S. Pat. No. 3,997,115, Pridgen, U.S. Pat. No. 4,700,494, Steiner, U.S. Pat. No. 4,839,106, Steiner, et al., U.S. Pat. No. 5,338,495, Junkel, et al., U.S. Pat. No. 5,620,633, Junkel, et al., U.S. Pat. No. 5,667,731, Zimmerman, U.S. Pat. No. 6,827,290, Hsu, U.S. Pat. No. 5,752,662, Junkel, et al., U.S. Des. 397,427, Radtke, et al., U.S. Des. 387,852, Radtke, et al., U.S. Des. 386,572, and Steiner, et al., U.S. Des. 349, 954.

The above-described references are hereby incorporated by reference in full.

The prior art teaches various portable fan devices adapted for use with a spray misting bottle. However, the prior art does not teach a packaging for a fluid such as lotion having the advantages described below. The present invention fulfills these needs and provides further related advantages as described in the following summary.

### SUMMARY OF THE INVENTION

The present invention teaches certain benefits in construction and use which give rise to the objectives described below.

The present invention provides a packaging for dispensing a fluid. The packaging includes a container for containing the fluid; a pump assembly adapted for dispensing the fluid from the container; a fan housing mounted on the container; a fan assembly; a motor mounted in the fan housing and operably connected to the fan assembly; a battery; and a switch operably connecting the motor and the battery.

A primary objective of the present invention is to provide a packaging having advantages not taught by the prior art.

Another objective is to provide a packaging that includes a fan assembly that, when in motion, catches the eye and makes the product more desirable to purchase.

A further objective is to provide a packaging for a fluid such as a lotion that also includes a fan assembly for cooling the user once the fluid has been applied to a user.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a perspective view of a packaging according to a preferred embodiment of the present invention;

FIG. 2 is a rear perspective view thereof;

FIG. 3 is a sectional view thereof taken along line 3-3 in FIG. 2;

FIG. 4 is an exploded perspective view of a fan assembly; and

FIG. 5 is a side elevational view thereof, illustrating the fan assembly being moved from a horizontal orientation to an upwardly-angled orientation.

### DETAILED DESCRIPTION OF THE INVENTION

The above-described drawing figures illustrate the invention, a packaging 10 for dispensing a fluid 12. Generally, the packaging 10 includes a container 20 for containing the fluid 12; a pump assembly 30 adapted for dispensing the fluid 12 from the container 20; a fan housing 42 mounted on the container 20; a fan assembly 60 rotatably mounted on the fan housing 42; a motor 74 mounted in the fan housing 42; a battery 78; and a switch SW operably connecting the motor 74 and the battery 78. The fan assembly 60, when in motion, catches the eye and makes the product more desirable to purchase. The fan assembly 60 also functions to cool the user once the fluid 12 has been applied.

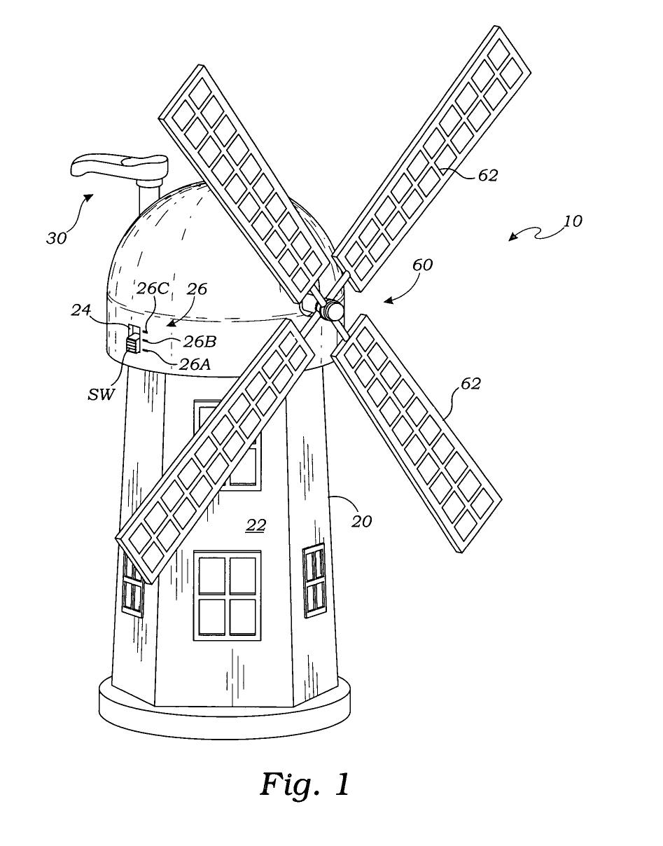

In the preferred embodiment, as shown in FIG. 1, the packaging 10 is adapted for dispensing a fluid 12 such as a lotion, and is adapted to resemble a windmill. In this embodiment, the container 20 includes a decorative outer surface 22 that resembles a windmill. The fan assembly 60 is adapted to resemble the blades of a windmill. While one particular design is shown, those skilled in the art may adapt the teachings of the present invention to display windmills of alternative designs, or even non-windmill designs that are similar in attractiveness to the consumer.

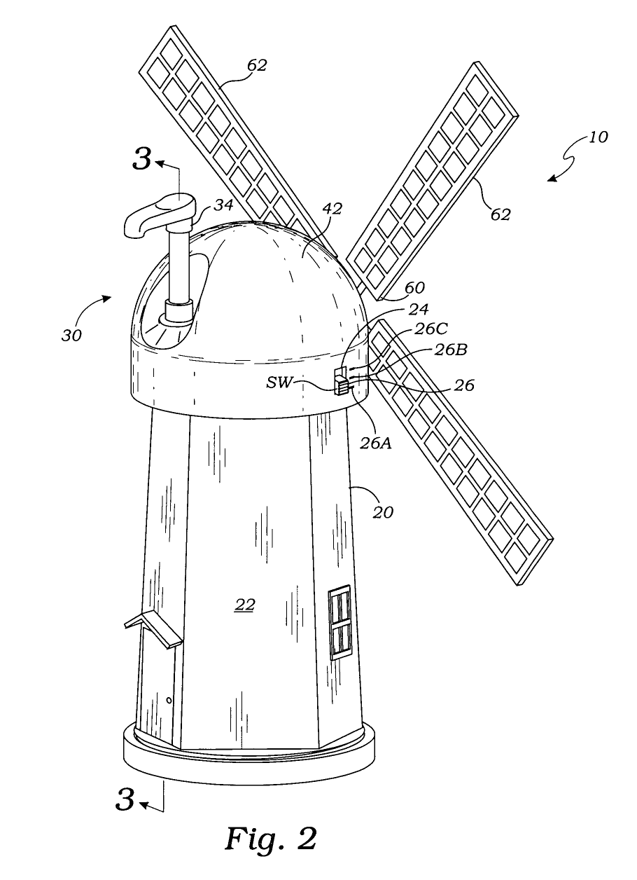

As shown in FIG. 2, the packaging 10 includes a pump assembly 30 for dispensing the fluid 12 from the container 20. The packaging 10 also includes a slot 24 for the switch SW, the slot 24 preferably including three position markers 26 for controlling the speed of the motor 74, most preferably a stopped position 26A, a low speed marker 26B for operating at a display speed, and a high speed marker 26C for operating at a cooling speed.

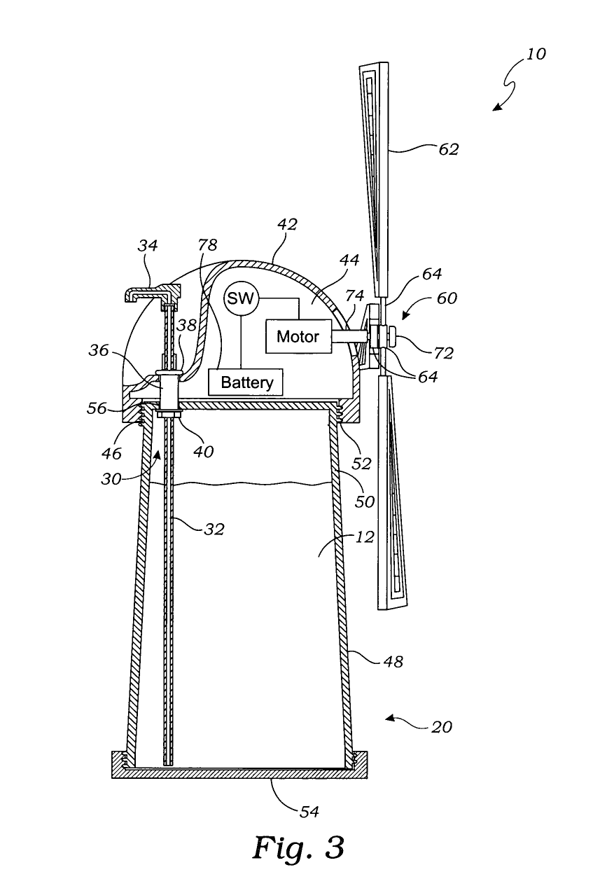

As shown in FIG. 3, the pump assembly 30 preferably includes a fluid line 32 extending into the container 20, a pump head 34, and a pump base 36. The pump head 34 is designed to reciprocate with respect to a pump base 36 such that the fluid 12 is pumped up the fluid line 32 and out the pump head 34.

In assembly, the pump base 36 most preferably includes a top flange 38 and a base nut 40 that together lock the pump base 36 in a position such that it extends through the container 20, and preferably through a fan housing 42 as well, although this is not required in alternative embodiments of the packaging 10.

In one embodiment as shown in FIG. 3, the fan housing 42 includes an interior chamber 44 that is adapted to house the motor 74 and the battery 78, and wherein the fan housing 42 is adapted to be mounted on top of the container 20. In this embodiment, the container 20 includes a top end 50 having a threaded portion 52, and the fan housing 42 includes an internally threaded portion 46 that engages the threaded portion 52 of the container 20 for mounting the fan housing 42 on the container 20.

In one embodiment, as shown in FIG. 3, the container 20 includes a container body 48 and a base 54. The base 54 is adapted to threadedly engage the container body 48 once the fluid 12 has been added to the container body 48. The pump base 36 fits through a pump aperture 56 of the container 20 and seals the pump aperture 56, the container 20 is filled with the fluid 12 through an open bottom, and then the base 54 is engaged to the container 20 to close the open bottom. A reversal of this construction, wherein the base 54 is located at the top of the container body 48, and wherein the base 54 includes the pump aperture 56, is expressly defined to be within the scope of the claimed invention.

In assembly, the battery 78, the switch SW, and the motor 74 are all assembled in the fan housing 42, which is attached to the container 20.

The pump base 36 is then fitted through the pump aperture 56 and locked in place with the base nut 40. The container 20 is then filled with the fluid 12, and finally, the base 54 is attached to the container 20, sealing the container 20.

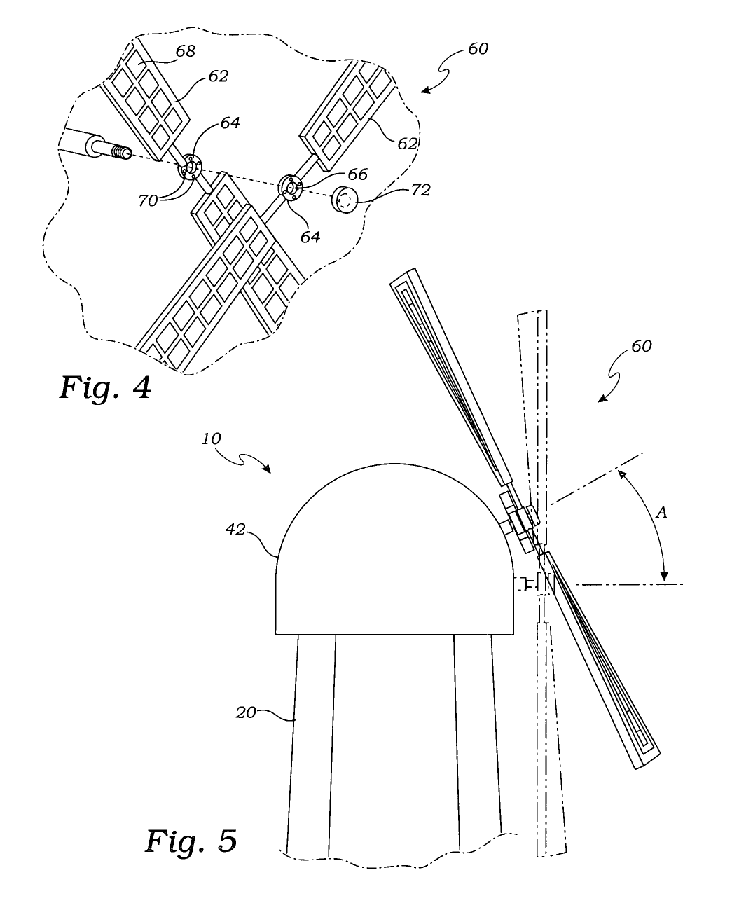

In the preferred embodiment, as shown in FIGS. 3-4, the fan assembly 60 preferably includes a plurality of blades 62 that are adapted to engage each other for form the fan assembly 60. This construction allows the fan assembly 60 to be stored and shipped is a disassembled configuration, and only assembled when ready for retail sale. As shown in FIGS. 3-4, each of the plurality of blades 62 includes an interior portion 64 having a mounting aperture 66, and an exterior blade portion 68 that is angled with respect to the direction of movement of the plurality of blades 62. The interior portion 64 preferably includes locking notches 70 or similar shaped portions to lock the plurality of blades 62 in their correct orientation with respect to each other, and with respect to a post 76 of the motor 74, when locked in place with a locking nut 72.

In the embodiment of FIG. 5, the fan assembly 60 may be pivoted between a first, horizontal position and a second, upwardly-angled position. In this embodiment, the motor 74 or the post 76 is preferably adapted to pivot so that the fan assembly 60 may be adjusted to the needs of the user.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A packaging for dispensing a fluid, the packaging comprising:
a container for containing the fluid;
a pump assembly adapted for dispensing the fluid from the container;
a fan housing mounted on the container;
a fan assembly;
a motor mounted in the fan housing and operably connected to the fan assembly;
a battery; and
a switch operably connecting the motor and the battery.

2. The packaging of claim 1 wherein the pump assembly includes a fluid line extending into the container, a pump base, and a pump head, the pump head being designed to reciprocate with respect to a pump base such that the fluid is pumped up the fluid line and out the pump head.

3. The packaging of claim 1 wherein the fan housing includes an interior chamber that is adapted to house the motor and the battery, and wherein the fan housing is adapted to be mounted on top of the container.

4. The packaging of claim 3 wherein the container includes a top end having a threaded portion, and wherein the fan housing includes an internally threaded portion that engages the threaded portion of the container for mounting the fan housing on the container.

5. The packaging of claim 1 wherein the fan assembly includes a plurality of blades that are adapted to engage each other for form the fan assembly.

6. The packaging of claim 5 wherein each of the plurality of blades includes an interior portion having a mounting aperture, and an exterior blade portion that is angled with respect to the direction of movement of the plurality of blades.

7. The packaging of claim 6 wherein the fan assembly is adapted to be mounted on a post of the motor and locked in place with a locking nut.

8. The packaging of claim 1 wherein the fan assembly is mounted on a post of the motor, and wherein the fan assembly may be pivoted between a first position and a second position.

9. The packaging of claim 1 wherein the container includes a decorative outer surface.

10. The packaging of claim 9 wherein the decorative outer surface resembles a windmill.

11. The packaging of claim 1 wherein the motor operates at two speeds, a low display speed and a high cooling speed.

12. A packaging for dispensing a fluid, the packaging comprising:
a container for containing the fluid;
a pump assembly adapted for dispensing the fluid from the container;
a fan housing mounted on the container;
a fan assembly rotatably mounted on or adjacent to the fan housing, the fan assembly including a plurality of blades that are adapted to engage each other for form the fan assembly;
a motor mounted in the fan housing and operably connected to the fan assembly;
a battery; and
a switch operably connecting the motor and the battery.

13. The packaging of claim 12 wherein each of the plurality of blades includes an interior portion having a mounting aperture, and an exterior blade portion that is angled with respect to the direction of movement of the plurality of blades.

14. The packaging of claim 13 wherein the fan assembly is adapted to be mounted on a post of the motor and locked in place with a locking nut.

15. The packaging of claim 12 wherein the fan assembly is mounted on a post of the motor, and wherein the fan assembly may be pivoted between a first position and a second position.

16. A packaging for dispensing a fluid, the packaging comprising:
a container for containing the fluid;
a pump assembly adapted for dispensing the fluid from the container;
a motor;
a battery;
a switch operably connecting the motor and the battery;
a fan housing mounted on the container, the fan housing including an interior chamber that is adapted to house the motor and the battery, and wherein the fan housing is adapted to be mounted on top of the container;
a post extending from and operably connected to the motor through the fan housing;
a fan assembly rotatably mounted on the post.

17. The packaging of claim 16 wherein the motor operates at two speeds, a low display speed and a high cooling speed.

18. The packaging of claim 16 wherein the fan assembly includes a plurality of blades, and wherein each of the plurality of blades includes an interior portion having a mounting aperture, and an exterior blade portion that is angled with respect to the direction of movement of the plurality of blades.

19. The packaging of claim 17 wherein the fan assembly is adapted to be mounted on a post of the motor and locked in place with a locking nut.
